(19) United States
(12) Patent Application Publication
(10) Pub. No.: US 2003/0052625 A1
(43) Pub. Date: Mar. 20, 2003

(54) CRT with reduced line deflection energy

(76) Inventors: Dirk Willem Harberts, Eindhoven (NL); Boris Skoric, Eindhoven (NL); Marcellinus Petrus Carolus Michael Krijn, Eindhoven (NL)

Correspondence Address: U.S. Philips Corporation, 580 White Plains Road, Tarrytown, NY, 10591, US

(21) Appl. No.: 10/242,931

(22) Filed: Sep. 13, 2002

(30) Foreign Application Priority Data
Sep. 18, 2001 (EP) 01203525.9

(51) Int. Cl. H01J 29/56

(52) U.S. Cl. 315/371

(57) ABSTRACT

The invention comprises a cathode ray tube having a line coil (15) for deflecting an electron beam (6,7,8) in a horizontal direction and a frame coil (13)′ for deflecting the electron beam in vertical direction. The line coil (15) comprises two line coil halves (17,19) that are operated with currents I_{N}, I_{S}, respectively, which are a function of the position of the deflected beam. This substantially reduces energy dissipation of the line coil (15). In an advantageous embodiment the tube further comprises a quadrupole coil (14) for correction of an asymmetry in the line magnetic field caused by the asymmetric driving of the line coil (15).

The invention relates to a cathode ray tube comprising a screen portion, means for generating an electron beam, and a deflection unit for deflecting the electron beam across the screen portion, the deflection unit comprising a line coil having a first coil half and a second coil half and a set of frame coils.

Such cathode ray tubes (CRT's) are known. The deflection unit of a conventional CRT comprises a line coil set that deflects the electron beam in a preferably horizontal direction, and a coil, the frame coil, that deflects the electron beam in a vertical direction. The line and frame coils are operated at respective line and frame frequencies. The line coil has two coil halves, located at North (upper half) and South (lower half) positions of the tube.

In slim CRT's and in CRT's which are operated at a high line frequency for improved image quality, energy dissipation in the deflection coils becomes a severe problem. Operating temperatures within the deflection unit can become so high that parts begin to deform or melt. The main contribution to the dissipation comes from energy losses due to the line coil.

It is an object of the invention to reduce the energy dissipation due to the line coil. The cathode ray tube according to the invention is characterized in that during operation the currents I_{N}, I_{S} through the first coil half and the second coil half, respectively, are non-identical functions of Xs and Ys, Xs and Ys being coordinates of a point of intersection of the electron beam with the screen portion. By operating the first coil half and the second coil half with unequal currents, such that a the two currents depend on the position of the deflected beam, the total current through the line coil can be substantially reduced and an energy reduction is obtained. If, e.g. the beam is deflected upward, it is situated closer to the upper than to the lower line coil half. Then it is very effective to deflect the beam in the horizontal direction by sending more current through the upper coil than through the lower coil half.

This aspect as well as other aspects of the invention are defined by the independent claims.

Advantageous embodiments of the invention are defined by the dependent claims.

These and other aspects of the invention will be elucidated with reference to the embodiments described hereinafter.

In the drawings,

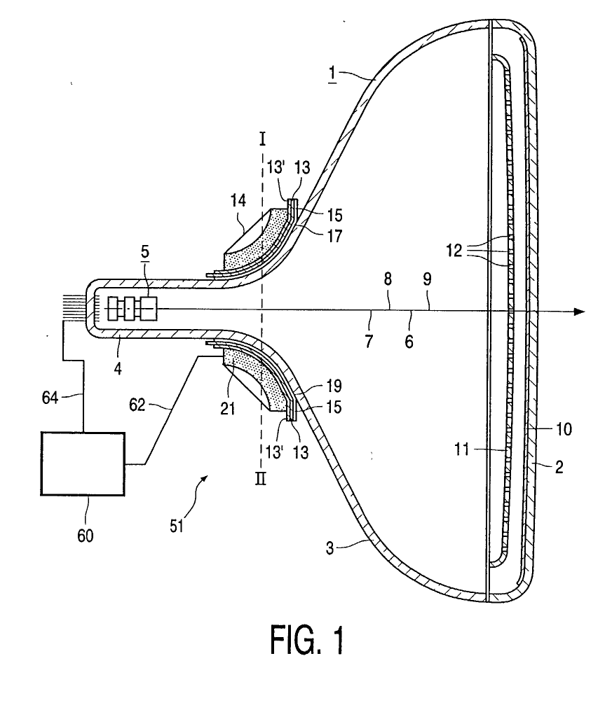

FIG. 1 is a sectional view of a cathode ray tube,

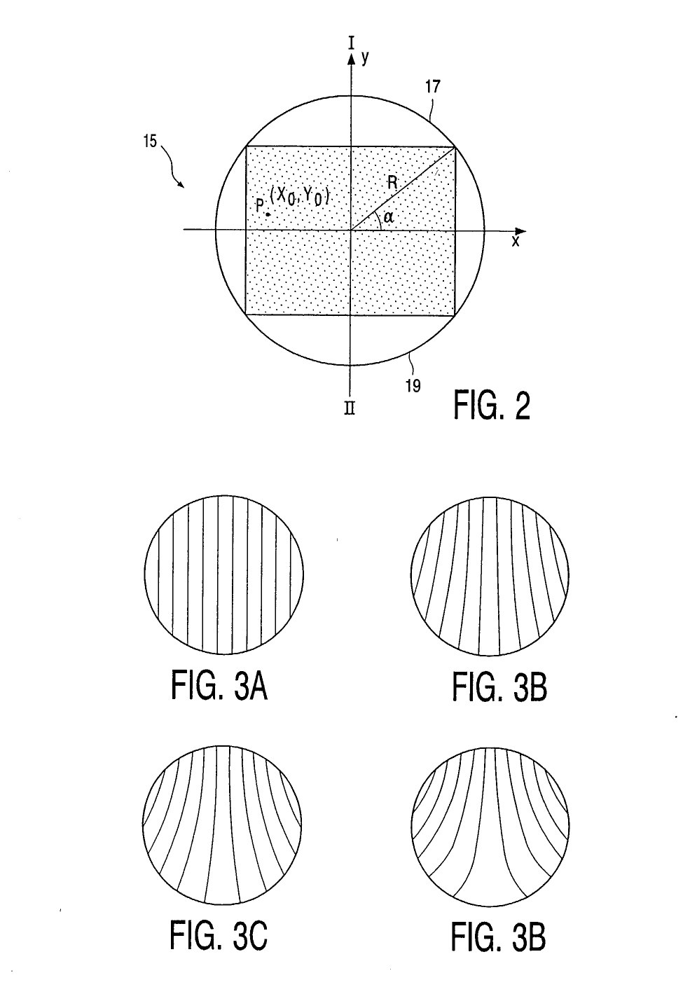

FIG. 2 shows a cross-section through the line coil,

FIGS. 3A to 3D show asymmetry errors in the calculated magnetic field with increasing ΔI,

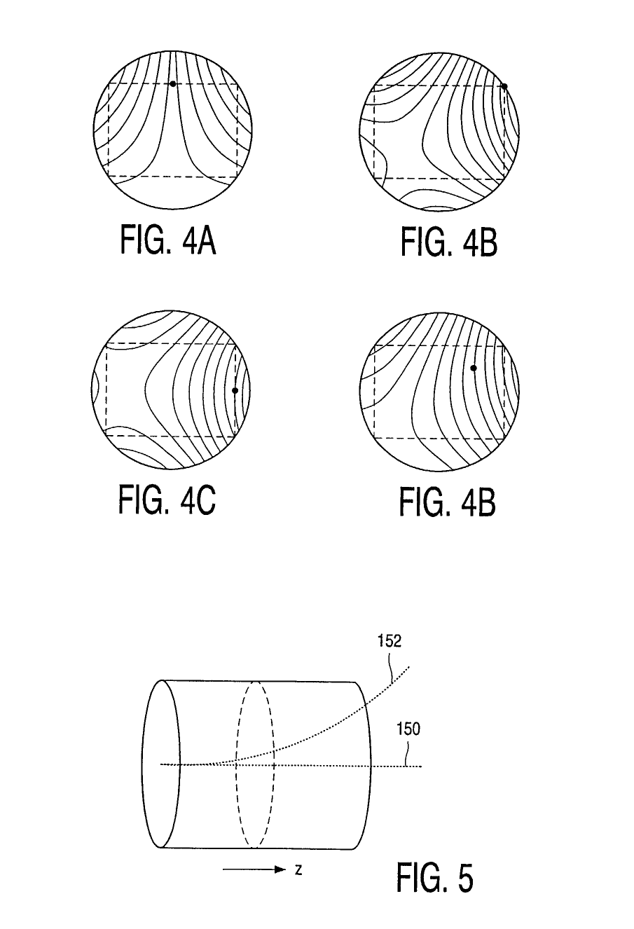

FIGS. 4A to 4D show the magnetic field lines at optimal driving,

FIG. 5 indicates the deflection region,

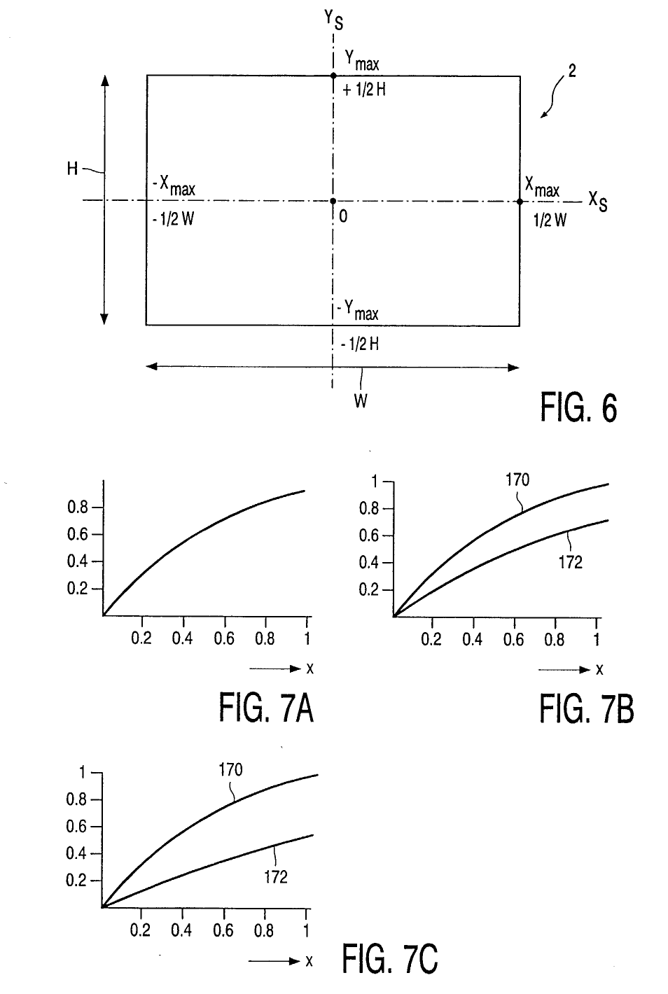

FIG. 6 shows a coordinate system related to the screen,

FIGS. 7A, 7B and 7C show calculated driving currents through the north coil I_{N} and through the south coil I_{S} for various beam positions, respectively,

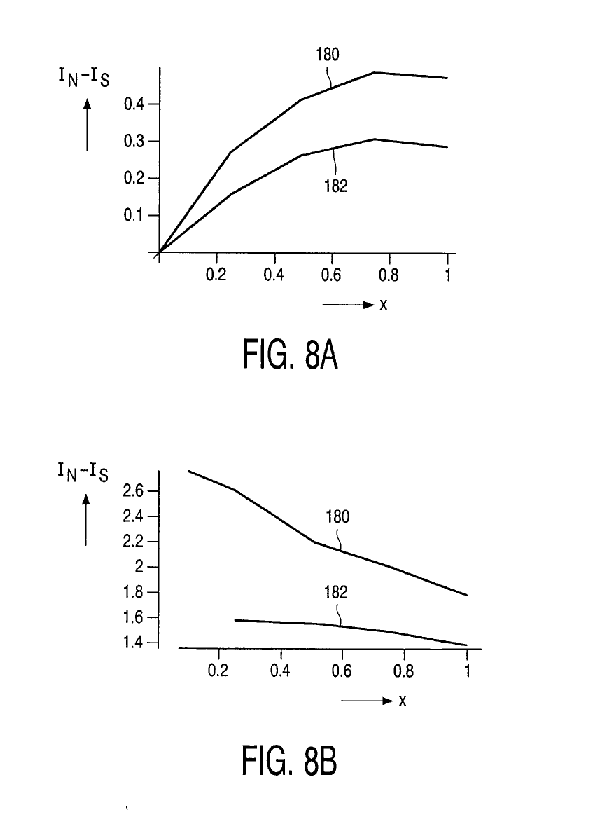

FIGS. 8A, 8B show the difference I_{N}−I_{S} and the ratio I_{N}/I_{S}, respectively, as a function of the x-deflection, and for two values of y-deflection,

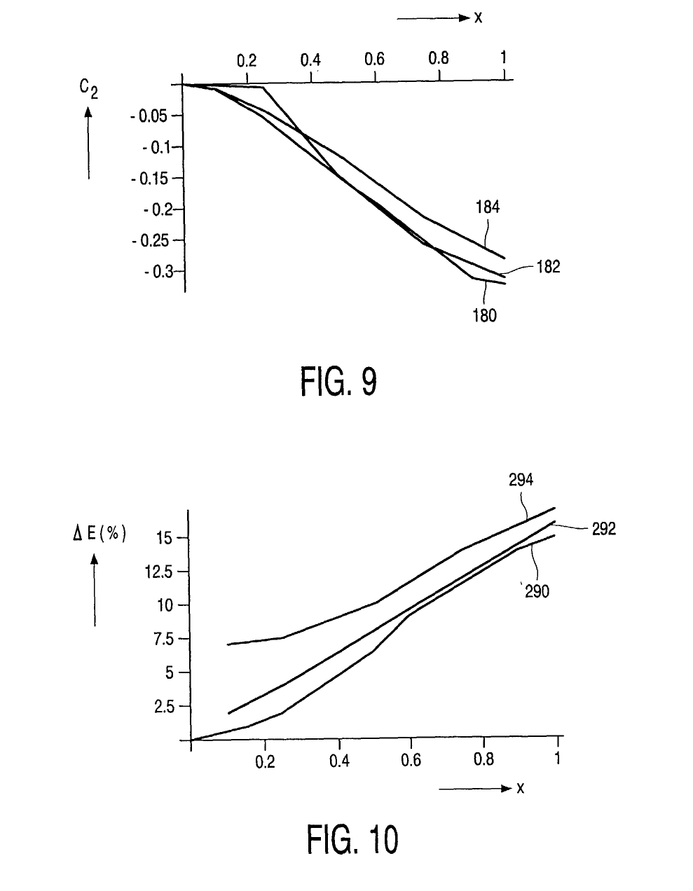

FIG. 9 shows the strength c₂ of the correction quadrupole, and

FIG. 10 shows the energy gain ΔE as a function of the screen position.

The figures are not drawn to scale. In general, identical components are denoted by the same reference numerals in the figures.

The display device according to the invention shown in FIG. 1 comprises a cathode ray tube, in this example a color display tube, having an evacuated envelope 1 which includes a display window 2, a cone portion 3 and a neck 4. In the neck 4 there is arranged an in-line electron gun 5 for generating three electron beams 6, 7 and 8 which extend in one plane, the in-line plane, which is in this case the plane of the drawing. In the undeflected state, the central electron beam 7 substantially coincides with the tube axis 9.

The inner surface of the display window is provided with a display screen 10. The display screen 10 comprises a large number of phosphor elements luminescing in red, green and blue. On their way to the display screen, the electron beams are deflected across the display screen by way of an electromagnetic deflection unit 51 and pass through a color selection electrode 11 which is arranged in front of the display window 2 and which comprises a thin plate having apertures 12. The three electron beams 6, 7 and 8 pass through the apertures 12 of the color selection electrode at a small angle relative to each other and hence each electron beam impinges only on phosphor elements of one color. The deflection unit 51 comprises, in addition to a coil separator 13, line deflection coils 15 and frame deflection coils 13′ for deflecting the electron beams in two mutually perpendicular directions and a yoke ring 21 that surrounds the line and frame coils. Because of the symmetry properties of the required magnetic deflection fields, the line coil 15 comprises two coil halves 17, 19 also known as the North (upper) and South (lower) line coil, respectively.

The line coil 15 and the frame coil 13′ are operated with currents having a line and a frame frequency, respectively. In a conventional CRT a current I_{N} through the North coil half 17 is equal to a current I_{S} through the South coil half 19. In the CRT according to the invention the currents I_{N}, I_{S} through the first coil half and the second coil half, respectively, are non-identical functions of Xs and Ys, (Xs and Ys being coordinates of an intersection of the electron beam with the screen portion as is shown in FIG. 5). This reduces the energy of the line magnetic field required for deflecting the beams 6,7,8.

A cross-section along the line I-II through the deflection unit 51 is schematically indicated.

In an advantageous embodiment the tube further comprises a quadrupole coil 14 for correction of an asymmetry in the line magnetic field caused by the asymmetric driving of the line coil. This quadrupole coil 14 may be situated near the deflection unit 51.

In a further advantageous embodiment of the invention the tube is driven such that a current I_{quad} running through the quadrupole coil 14 is only a function of Ys. This embodiment has the advantage of being simple to implement.

A further aspect of the invention provides a display apparatus comprising the cathode ray tube according to the invention, and circuitry 60 for providing control signals 62 and display signals 64 to the display.

FIG. 2 shows a cross-section through the line I-II of the line coil 15, which is perpendicular to the tube axis 9. The upper 17 and the lower 19 half of the line coil are schematically indicated. A rectangular X, Y coordinate system is indicated, wherein x₀ and y₀ are coordinates of a point of intersection P of the electron beam with a plane formed by the cross-section; i.e. the position of the beam is denoted by x₀ and y₀. Further, R denotes a radius of the line coil and hence is situated at r=R(r=\sqrt{x²+y²}). The beam passes through a rectangular (shaded) region with aspect ratio tan α.

The principle on which the invention is based, may be understood using a two-dimensional model that gives a relation between the driving currents and the magnetic energy contained in a plane perpendicular to the tube axis.

It is possible to write a magnetic field \vec{H} inside the deflection region as the gradient of a magnetic potential Φ: \vec{H}=−∇Φ. In general, the potential is of the form:

$$Φ ( r , θ ) = {\sum }_{n = 1}^{∞} {( r / R )}^{n} ( {c}_{n} sin n θ + {d}_{n} cos n θ ) ,$$

(r,θ) denoting polar coordinates. The constants cₙ and dₙ are the magnetic field strengths of the line and frame multipole components, respectively. (If n=1: Φ represents a dipole field, n=2 a quadrupole field, n=3 hexapole, etc.). These fields depend on the currents through all the coils.

The magnetic energy LI² is given by

$$L {I}^{2} = π {\sum }_{n = 1}^{∞} n ( {c}_{n}^{2} + {d}_{n}^{2} ) .$$

In case of symmetric driving of the line coil halves 17,19 a pure dipole field in the y-direction is generated. This corresponds to a current distribution given by i(θ)=−I cosθ, with I the current flowing through both the upper and the lower line coil halves. This leads to c₁=−I₀, while all other coefficients cₙ, dₙ are zero. The magnetic field is constant with Hₓ=0 and H_{y}=I₀/R. The magnetic energy of the symmetrically driven situation as occurring in a CRT that is conventionally driven is given by LI²=πI₀².

If the line coil 15 is operated by driving the upper (‘North’) line coil half 17 by a current I_{N} and the lower (‘South’) half 19 by a current I_{S}, with I_{N}≠I_{S}, the asymmetry will induce even frame multipoles d₂, d₄, d₆, etc. We denote the difference I_{N}−I_{S} by ΔI and the average (I_{N}+I_{S})/2 by I_{Av}. The strengths of the multipole coefficients are given by

$${c}_{1} = - {I}_{A v} ; {d}_{n} = \frac{2 Δ I}{π ( {n}^{2} - 1 )} ,$$

n even.

FIGS. 3A to 3D show, for a specific position within the deflection unit, asymmetry errors in the calculated magnetic field with increasing ΔI. Shown are the results for I_{N}=1 and I_{S} is 1, ½, ¼, 0 (FIGS. 3A, 3B, 3C, 3D, respectively). The H-field of the octopole component and higher order multipoles is at least 5 times weaker than the quadrupole field. Therefor it suffices to consider only the quadrupole component. The magnetic field has an unwanted x-component of strength

$${H}_{x} = - \frac{4}{3 π} Δ I \cdot x / {R}^{2} .$$

This unwanted Hₓ at beam position x₀, y₀ can be eliminated by applying a 45° quadrupole field with an x₀, y₀ dependent field strength given by

$${c}_{2} ( {x}_{0} , {y}_{0} ) = - \frac{2}{3 π} Δ I \frac{{x}_{0}}{{y}_{0}} .$$

FIGS. 4A to 4D show, for a specific position within the deflection unit, the magnetic field lines generated by the line coil halves 17,19 at optimal driving. A dot with coordinates x₀, y₀ represents the position of the electron beam. The line field at this point is always purely vertical. Averaged over all possible beam positions (represented by the shaded rectangle in FIG. 2) and choosing an aspect ratio tan α=¾, which is a realistic value in the deflection region of a 16:9 CRT, it can be calculated that the reduction in field energy is 48%.

This large reduction with respect to the symmetric driving case is partly caused by the quadrupole coil, which takes over part of the function of the line coil. A quadrupole field contains less energy than a dipole field, since the quadrupole field is zero at the origin and grows linearly in the radial direction, whereas the dipole field remains constant. In view of this boosting effect by the quadrupole it is advantageous to use the correction coil even on the line axis y₀=0, where the line coil 15 is driven symmetrically.

While the above reasoning also applies to the full three-dimensional deflection unit, the numbers are valid only for a specific two-dimensional cross-section, i.e. at one particular value of the axial coordinate z. The beam position x₀, y₀ varies as a function of z. In general, a set of currents that is optimal for one plane is not optimal for all cross-sections. In order to find the optimum driving for the three-dimensional deflection unit, a set of currents has to be found that yields the lowest energy when averaged over the whole beam trajectory. The resulting overall energy reduction turns out to be less than 48% (as calculated for the two-dimensional analysis) but still substantial, i.e. between 15% and 20%.

In order to find the best driving currents in a realistic three-dimensional situation, the following numerical analysis was performed. The deflection unit was modelled as a cylinder as is shown in FIG. 5 and the screen as a rectangle with aspect ratio 9:16. Curve 152 represents the deflection of the electron beam as a function of the z-coordinate and curve 150 indicates the central axis of the tube. The deflection angle from the tube axis to the comer was taken to be 53° and the distance from the cylinder to the screen was taken to be 6.25 times the length of the cylinder. The diameter of the cylinder is 0.97 times its length. Over the whole length of the cylinder a frame coil and a line coil are assumed to be present. The line coil is driven asymmetrically. Both line and frame coil are such that they produce a pure dipole field when driven symmetrically. Around the second half of the deflection region a 45° quadrupole coil is also present.

Reference will be made to the position of the beam on the screen 2 throughout the following analysis. To this end a rectangular coordinate system having its origin O positioned in the middle of the screen is introduced, as is indicated in FIG. 6. The coordinates of the intersection of the beam with the screen are denoted by Xs and Ys. The screen has a width W and a height H. Hence, the maximum values of Xs and Ys do occur at ½ W and ½ H, respectively. Due to symmetry reasons it suffices to show the results of the calculations for positive Xs and Ys values (the upper right quadrant). For every position on the screen an optimal combination of I_{N}, I_{S} and c₂ was determined numerically. The numerical results are shown in FIG. 7 to FIG. 10. Relative x- and y-coordinates are introduced for the sake of simplicity, which are equal to Xs/Xmax and Ys/Ymax, respectively. Hence, x and y vary between 0 and 1, and x=1 corresponds to maximum East deflection. Calculated currents have been scaled to the current which is required to obtain maximum East deflection.

FIGS. 7A, 7B, 7C give the calculated optimal currents I_{N} and I_{S} through the upper and lower half of the line coil as a function of the horizontal x-deflection for three values of the vertical y-deflection, respectively. FIG. 7A indicates the results for y=0. In this case the currents I_{N} and I_{S} are equal to each other. In FIGS. 7B, 7C the upper curve 170 and the lower curve 172 indicate the results for I_{N} and I_{S}, respectively. FIG. 7C shows the results for maximal y-deflection and FIG. 7B for y-deflection equal to half of the maximum y-deflection.

FIGS. 8A, 8B give the difference I_{N}−I_{S} and the ratio I_{N}/I_{S} as a function of the x-deflection, respectively, for two values of y-deflection, i.e. at maximum y-deflection (the upper curve 180 ) and at y equal to half the maximum y-deflection (curve 182). The relative asymmetry between I_{N}/I_{S} increases with the vertical deflection and decreases with the horizontal deflection. At y=0 there is no asymmetry, while it can grow to I_{N}/I_{S}>2.7 at maximum y-deflection. The absolute asymmetry I_{N}−I_{S}, on the other hand, increases with growing x and y-deflection. The largest absolute asymmetry occurs approximately in the comers of the screen: there the current difference is 45% of the nominal current conventionally needed for maximum x-deflection.

From FIGS. 7, 8 it can be concluded that if a ratio Iₘₐₓ/Iₘᵢₙ>1.02, Iₘₐₓ being the largest and Iₘᵢₙ the smallest value of the currents {|I_{N}|,|I_{S}|} and |X_{S}|,|Y_{S}| both being larger than 0.125 of a width W and a height H of the screen portion 2, respectively, an energy reduction is obtained (this corresponds to x and y-values larger than 0.5). The value of 1.02 has been chosen to distinguish from the case of conventional driving. Although, in principle in conventional driving the currents through North and South coil halves of the line coil are identical, in practice slight differences may occur. Cathode Ray tube manufacturers accept an unbalance of at maximum 2%.

The optimal quadrupole strength c₂ (which is a measure of the required current I_{quad} through the quadrupole coil) related to the calculated optimal currents I_{N} and I_{S} is shown in FIG. 9. Curves 190, 192 and 194 indicate the results for y=0, 1/2 yₘₐₓ and yₘₐₓ, respectively. It mainly depends on the horizontal deflection, and the relation with x is approximately linear.

FIG. 10 shows the energy gain ΔE (in %) as a function of the screen position. Curves 290, 292 and 294 indicate the results for y=0, 1/2 yₘₐₓ and yₘₐₓ, respectively. For maximum x-deflection the energy gain is between 15% (East) and 17% (corner).

In order to find the total energy gain one has to integrate over the whole screen. The large energies near maximum x-deflection dominate and a total energy gain of more than 15% is obtained.

Good results were obtained when the quadrupole coil 14 comprised a so-called 45 degrees quadrupole coil, i.e. a quadrupole coil of which the coil segments make an angle of 45 degrees with the line and the frame axis.

Additionally, a so-called 90 degrees quadrupole coil can be used, as well as higher order magnetic multipole coils. Such coils have the advantage of being able to further correct residual raster and convergence errors.

In summary, the invention comprises a cathode ray tube having a line coil 15 for deflecting an electron beam in horizontal direction and a frame coil 13′ for deflecting the electron beam in vertical direction. The line coil 15 comprises two line coil halves 17,19 that are operated with currents I_{N}, I_{S}, respectively, which are a function of the position of the deflected beam. This substantially reduces energy dissipation of the line coil 15. In an advantageous embodiment the tube further comprises a quadrupole coil 14 for correction of an asymmetry in the line magnetic field caused by the asymmetric driving of the line coil 15.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements or steps than those listed in a claim. The word “a” or “an” preceding an element does not exclude the presence of a plurality of such elements.

1. A cathode ray tube comprising:
a screen portion (2),
means (5) for generating an electron beam (6,7,8), and
a deflection unit (51) for deflecting the electron beam (6,7,8) across the screen portion (2), the deflection unit (51) comprising a line coil (15) having a first coil half (17) and a second coil half (19) and a set of frame coils (13′),
wherein during operation the currents I_{N}, I_{S} through the first coil half (17) and the second coil half (19), respectively, are non-identical functions of Xs and Ys,
Xs and Ys being coordinates of a point of intersection of the electron beam with the screen portion (2).

2. A cathode ray tube according to claim 1, wherein a ratio Iₘₐₓ/Iₘᵢₙ>1.02, Iₘₐₓ being the largest and Iₘᵢₙ the smallest value of the currents {|I_{N}|,|I_{S}|}, and |X_{S}|,|Y_{S}| both being larger than 0.125 of a width W and a height H of the screen portion (2), respectively.

3. A cathode ray tube according to claim 1, wherein the tube further comprises correcting means (14) for correcting an asymmetry in a magnetic field generated by the line coil (15).

4. A cathode ray tube according to claim 3, wherein the correcting means (14) comprise a quadrupole coil for generating a magnetic quadrupole field.

5. A cathode ray tube according to claim 4, wherein the quadrupole coil (14) comprises a 45 degrees quadrupole coil.

6. A cathode ray tube according to claim 3, 4 or 5, wherein a current I_{quad} running through the correcting means (14) is a function of Xs and Ys.

7. A cathode ray tube according to claim 6, wherein a current I_{quad} running through the correcting means (14) is only a function of Ys.

8. A display apparatus comprising:
the cathode ray tube according to claim 1, and means (60) for providing control signals (62) and display signals (64) to the tube.
